(19) United States
(12) Patent Application Publication
(10) Pub. No.: US 2026/0243284 A1
(43) Pub. Date: Aug. 20, 2026

(54) FIXING DEVICE AND METHOD FOR FIXING A COMPONENT

(71) Applicant: ElringKlinger AG, Dettingen (DE)

(72) Inventors: Adrian MAIER, Dettingen (DE); Beate GALLANDT, Dettingen (DE); Alexander LEICHTFUSS, Dettingen (DE); Moritz LAUFER, Dettingen (DE); Stefan KAZMAIER, Dettingen (DE); Tanja NITSCH, Dettingen (DE); Andreas HAUBITZ, Dettingen (DE); Jan MAURER, Dettingen (DE)

(73) Assignee: ElringKlinger AG, Dettingen (DE)

(21) Appl. No.: 19/643,681

(22) Filed: Apr. 9, 2026

Related U.S. Application Data
(63) Continuation of application No. PCT/EP2024/079993, filed on Oct. 23, 2024.

(30) Foreign Application Priority Data
Oct. 30, 2023 (DE) 10 2023 129 983.2

(51) Int. Cl. F16B 5/00

(52) U.S. Cl. CPC F16B 5/0096

(57) ABSTRACT

In order to provide a fixing device which is intended for fixing a component, allows for secure fixing of the component and is of straightforward design, it is proposed that the fixing device should comprise a main body, on which is provided at least one fastening portion for receiving the component, wherein the fastening portion has at least one fixing element which can be inserted into a through-passage provided in the component and, for the purpose of fixing the component, can be at least partially deformed in the through-passage, wherein, as a result of the deformation, the fixing element is in engagement with at least one depression provided on the component and/or with at least one protrusion provided on the component.

### RELATED APPLICATION

This application is a continuation of international application No. PCT/EP2024/079993 filed on October 23, 2024, and claims the benefit of German application No. 10 2023 129 983.2 filed on October 30, 2023, which are incorporated herein by reference in their entirety and for all purposes.

### FIELD OF DISCLOSURE

The present invention relates to a fixing device for fixing a component and to a method for fixing a component.

### BACKGROUND

The prior art discloses devices which are intended for fixing components and in which, as a result of tolerances, secure fixing of the component is not always ensured.

### SUMMARY OF INVENTION

The present invention is based on the object of providing a fixing device which is intended for fixing a component, allows for secure fixing of the component and is of straightforward design.

This object is achieved according to the invention by a fixing device which is intended for fixing a component and comprises a main body, on which is provided at least one fastening portion for receiving the component, wherein the fastening portion has at least one fixing element which can be inserted into a through-passage provided in the component and, for the purpose of fixing the component, can be at least partially deformed in the through-passage, wherein, as a result of the deformation, the fixing element is in engagement with at least one depression provided on the component and/or with at least one protrusion provided on the component.

The main body can be any desired part on which the component is to be fixed, for example a housing element, a wall element, a structural element or the like.

The main body can preferably be part of a motor vehicle, for example a bodywork element, a trim or panelling element, an electronic device, a battery unit, for example a battery-housing component, or the like.

The fastening portion can be formed by a bearing surface on the main body. In order for the component to be arranged on the fastening portion, it is possible for the bearing surface both to be of planar design and to have a structure, for example for the purpose of positioning the component.

The fastening portion on the main body comprises one or more fixing elements, which extend away from the main body in a preferably stud-like manner.

In particular, the at least one fixing element is arranged orthogonally in relation to the fastening portion, for example the bearing surface for the component which is to be fixed.

The at least one fixing element is preferably in the form of a stud-like fixing element.

The at least one fixing element advantageously extends away from the main body, so that a free end portion is formed.

As a result, the component can be arranged on the fastening portion in such a manner that the at least one fixing element is inserted into the through-passage in the component.

The at least one fixing element extends in particular through the through-passage in the component, so that the free end portion of the at least one fixing element projects in relation to the component.

Since, as a result of the deformation, the at least one fixing element engages in the at least one depression and/or engages on the at least one protrusion, the component can be fixed in place relative to the main body.

A preferred development of the fixing device can make provision so that, as a result of the deformation, the at least one fixing element is plastically molded into the at least one depression and/or is plastically molded onto the at least one protrusion.

The deformation of the at least one fixing element causes the fixing element to be in particular at least partially plastically deformed.

The deformation in particular provides for the plastically deformed material of the at least one fixing element to engage in the at least one depression and/or to engage on the at least one protrusion.

Therefore, the deformation allows for interlocking between the at least one fixing element and the component, and this fixes the component.

It can be particularly advantageous if both at least one depression, into which the at least one fixing element can be plastically molded as a result of the deformation, and at least one protrusion, onto which the at least one fixing element can be plastically molded as a result of the deformation, are provided on the component.

An advantageous configuration of the fixing device can make provision so that, as a result of the at least one deformed fixing element engaging in the at least one depression and/or engaging on the at least one protrusion, the component is fixed in position in at least two spatial directions, in particular three spatial directions, and/or the component is secured against rotation.

As a result of the at least one fixing element deforming and engaging in the at least one depression and/or engaging on the at least one protrusion, it is possible for the component to be arrested relative to the main body, in particular fixed in position in the X direction, Y direction and Z direction.

In addition, as a result of the at least one fixing element deforming and engaging in the at least one depression and/or engaging on the at least one protrusion, it is possible for the component to be arrested in respect of rotation relative to the main body, in particular rotation about a longitudinal axis of the at least one fixing element.

One configuration of the fixing device can, in addition, make provision for the at least one depression and/or the at least one protrusion to be provided on an inner-wall portion of the through-passage and/or on a wall portion of the component that is adjacent to the through-passage.

The inner-wall portion of the through-passage is in particular a circumferential wall which delimits the through-passage.

The wall portion of the component that is adjacent to the through-passage is in particular a wall portion of the component that is directed away from the main body.

The wall portion of the component that is adjacent to the through-passage can preferably be a wall portion of the component that encloses or delimits the through-passage.

For example, it is possible for the wall portion adjacent to the through-passage to enclose the through-passage in an annular manner.

In a development of the fixing device, the at least one depression can be in the form of a recess, shaped portion, groove, flute, score, notch, indent, hole, blind hole, bore, cutout, aperture, structured surface and/or the like.

In particular, the at least one depression is not restricted to the aforementioned configurations; rather, it can be a depression of any desired configuration which is designed so that, as a result of the deformation, the at least one fixing element can be molded into it, in order to fix the component relative to the main body.

A further development of the fixing device can, in addition, make provision for the at least one protrusion to be in the form of a boss, shaped portion, elevation, corrugation, ridge, wedge, stud, lip, structured surface and/or the like.

In particular, the at least one protrusion is not restricted to the aforementioned configurations; rather, it can be a protrusion of any desired configuration which is designed so that, as a result of the deformation, the at least one fixing element can be molded onto it, in order to fix the component relative to the main body.

In a particularly advantageous configuration of the fixing device, a plurality of depressions and/or a plurality of protrusions can be provided on the component, and the at least partially deformed fixing element is in engagement therewith for the purpose of fixing the component.

Since, as a result of the deformation, the at least one fixing element engages in a plurality of depressions and/or engages on a plurality of protrusions, the component can be fixed particularly securely in the number of spatial directions. Such a fixing device can withstand for example relatively high loading on the component.

A development of the fixing device can make provision for the plurality of depressions and/or plurality of protrusions to be spaced apart from one another on the inner-wall portion of the through-passage and/or on a wall portion of the component that encloses the through-passage.

In particular, the plurality of depressions and/or plurality of protrusions can be spaced apart from one another on the inner-wall portion of the through-passage along a circumference and/or a through-passage direction.

It is likewise preferably possible for the plurality of depressions and/or plurality of protrusions to be spaced apart from one another on the wall portion of the component that encloses the through-passage.

The plurality of depressions and/or plurality of protrusions can be both symmetrically and asymmetrically formed on the inner-wall portion of the through-passage and/or on the wall portion of the component that encloses the through-passage.

In one configuration of the fixing device, the plurality of depressions and/or plurality of protrusions form a cross section of the through-passage provided in the component, this through-passage cross section having an inner multi-curve profile and/or an inner multi-edge profile.

Such an inner multi-curve profile and/or inner multi-edge profile can form a through-passage which has an essentially star-shaped, polygonal and/or polygonal/star-shaped through-passage cross section.

As a result of the deformation of the at least one fixing element, such a cross section of the through-passage can allow for fixing of the component which is particularly capable of withstanding loading.

In addition, such a cross section of the through-passage can be formable by a straightforward manufacturing process, as a result of which cost-effective production of the fixing device can be achieved.

It is advantageously possible, in the case of the fixing device, for the at least one fixing element to be hot formed for the purpose of fixing the component.

In particular, the at least one fixing element can be heat staked for the purpose of fixing the component.

In the case of hot forming, in particular heat staking, of the at least one fixing element, provision is preferably made for a heated punch of a processing tool to act on the fixing element in order to heat, preferably melt, it under the action of temperature and to deform it under the action of force.

It is thereby possible for the melted material of the at least one fixing element, under the action of force from the punch, to be plastically molded into the at least one depression and/or to be plastically molded onto the at least one protrusion.

A widened head region can advantageously be formed on a free end portion of the at least one fixing element, i.e. on an end portion of the fixing element that is located opposite the main body.

Such a widened head region on the fixing element can be used for example as a material reservoir, so that, for the deformation of the fixing element, there is sufficient material available to be molded into the at least one depression and/or to be molded onto the at least one protrusion.

In one configuration of the fixing device, the at least one fixing element can preferably be formed, at least in part, from a plastics material or from a metal material.

If the at least one fixing element is formed from a plastics material, the low melting point of the plastics material makes it possible for particularly straightforward hot forming of the at least one fixing element to be achieved.

In addition, using a plastics material allows a cost-effective configuration of the fixing device to be achieved.

If the at least one fixing element is formed from a metal material, it preferably has a low melting point. For example, the at least one fixing element can be formed from a light metal, in particular aluminum.

The main body and the at least one fixing element can advantageously be in the form of an integral part and can preferably be formed integrally from a plastics material or from a metal material.

One configuration of the fixing device can, in addition, make provision for the component to be in the form of a vehicle component.

However, the component is not restricted to such a vehicle component; rather, the component can form any desired part of a technical device.

In particular, the component can be in the form of a busbar, an electronic component, a fastening device, a holder or bracket, a clamp or clip and/or the like.

The invention is also based on the object of providing a method which is intended for fixing a component, allows for secure fixing of the component and is straightforward.

This object is achieved by a method for fixing a component, in particular using a fixing device according to one of the embodiments described above, comprising the following steps: a component which is to be fixed is arranged on a fastening portion of a main body by virtue of at least one fixing element of the fastening portion being inserted into at least one through-passage in the component, the at least one fixing element is deformed, in particular hot formed, and the component is fixed by virtue of the at least one deformed, in particular hot-formed, fixing element being plastically molded into at least one depression provided on the component and/or being plastically molded onto at least one protrusion provided on the component.

The hot forming gives rise in particular to at least partially plastic deformation of the fixing element, in the case of which the fixing element is at least partially melted.

In particular, the at least one fixing element is plastically deformed by a heat-staking process, in which a heated punch of a tool acts on the at least one fixing element. As a result, the at least one fixing element is at least partially melted and, under the action of force, is plastically molded into the at least one depression and/or is plastically molded onto the at least one protrusion.

In this way, the deformation provides for interlocking between the at least one fixing element and the component, and this fixes the component in place relative to the main body.

In a development of the method, provision can be made so that, as a result of the fixing element being plastically molded into the at least one depression and/or as a result of the fixing element being plastically molded onto the at least one protrusion, the component is fixed in position in at least two spatial directions, in particular three spatial directions, and/or the component is secured against rotation.

In particular it is possible, as a result of the fixing element being plastically molded into the at least one depression and/or as a result of the fixing element being plastically molded onto the at least one protrusion, for the component to be fixed in place in the X direction, Y direction and Z direction.

It is advantageously possible in addition, as a result of the fixing element being plastically molded into the at least one depression and/or as a result of the fixing element being plastically molded onto the at least one protrusion, for the component to be arrested in respect of rotation relative to the main body, in particular rotation about a longitudinal axis of the at least one fixing element.

Further preferred features and/or advantages of the invention form the subject of the following description and of the drawings of exemplary embodiments.

### BRIEF DESCRIPTION OF THE DRAWINGS

FIG. 1 shows a schematically perspective view of a fixing device according to one embodiment of the disclosure, in an initial state;

FIG. 2 shows a schematically perspective view of the fixing device in a fixing state;

FIG. 3 shows a perspective view of a schematic detail of a component of the fixing device according to an alternative embodiment;

FIG. 4 shows a plan view of a schematic detail of the component of the fixing device in a further alternative embodiment;

FIG. 5 shows a plan view of a schematic detail of the component of the fixing device in a further alternative embodiment;

FIG. 6 shows a plan view of a schematic detail of the component of the fixing device in a further alternative embodiment.

Identical or functionally equivalent elements are provided with the same reference signs in all the figures.

### DETAILED DESCRIPTION OF THE DRAWINGS

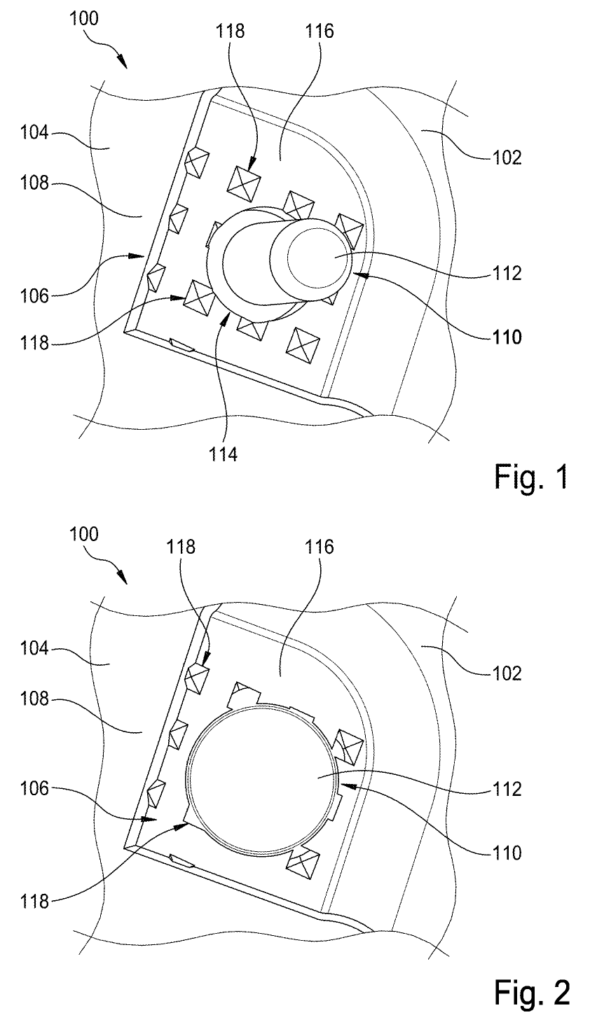

FIG. 1 shows a schematically perspective view of a fixing device according to one embodiment of the disclosure, the fixing device being denoted as a whole by 100.

The fixing device 100 is provided in order to fix a component 102 on a main body 104.

FIG. 1 shows the fixing device 100 in an initial state, in which the component 102 is arranged on the main body 104 and not yet fixed on the main body 104.

The main body 104 can form any desired part on which the component 102 is to be fixed. For example, the main body 104 can be a housing element, a wall element, a structural element or the like.

The main body 104 can preferably be any desired part of a motor vehicle, for example a bodywork element, a trim or panelling element, a structural element, an electronic device, a battery unit or the like of the motor vehicle.

The component 102 can likewise form any desired part which is to be fixed on the main body 104. For example, the component 102 can be an electronic component, a fastening device, a holder or bracket, a clamp or clip and/or the like.

In particular, the component 102 can be in the form of a busbar.

The component 102 can preferably form a part of a motor vehicle.

The fixing of the component 102 can constitute both permanent fixing and temporary fixing on the main body 104.

The main body 104 has formed on it a fastening portion 106, on which the component 102 is arranged for fixing purposes.

The fastening portion 106 comprises a bearing surface 108 on the main body 104 and also a fixing element 110.

It is likewise possible for the fastening portion 106 to comprise a plurality of fixing elements 110, for example two, three or more fixing elements 110.

The fixing element 110 extends away from the main body 104 in a stud-like manner from the bearing surface 108 of the fastening portion 106.

In particular, the fixing element 110 extends away from the main body 104 essentially orthogonally from the bearing surface 108 of the fastening portion 106.

Opposite the main body 104, the fixing element 110 has a free end portion 112.

A widening head region can be formed on the end portion 112 of the fixing element 110.

The fixing element 110 is preferably formed from a plastics material, for example a thermoplastic, or from a metal material, for example a light metal, in particular aluminum.

The main body 104 and the fixing element 110 are preferably configured integrally with one another, i.e. the fixing element 110 can be formed from the main body 104 or can be moulded onto the same.

A through-passage 114 is formed in the component 102.

The through-passage 114 extends through the component 102, in particular from a wall portion of the component 102 that faces the main body 104 to a wall portion 116 of the component 102 that is located opposite the main body 104.

It is also possible for a plurality of such through-passages 114 to be formed on the main body 102, so that a respective fixing element 110 can be fitted into each through-passage 114.

In order for the component 102 to be fixed, the component 102 is arranged on the fastening portion 106 in such a manner that the fixing element 110 is guided into the through-passage 114 in the component 102, as is illustrated in FIG. 1.

Provision is preferably made for an internal diameter of the through-passage 114 to be greater than an external diameter of the fixing element 110, in particular in such a manner that a gap is formed between the fixing element 110 and an inner wall of the through-passage 114.

The fixing element 110 here is of such a length that the free end portion 112 of the fixing element 110 projects in relation to the component 102 when the fixing element 110 has been guided through the through-passage 114.

In particular, the fixing element 110 projects in relation to a wall portion 116 of the component 102 that encloses the through-passage 114 when the fixing element 110 has been guided through the through-passage 114.

A multiplicity of depressions 118 are provided on the wall portion 116 of the component 102 that encloses the through-passage 114.

These depressions 118 can be in the form of pointed, conical or pyramid-shaped recesses.

The depressions 118 thus form a structured surface which is formed on the wall portion 116 so as to enclose in particular the through-passage 114.

However, the depressions 118 are not restricted to the embodiment illustrated; rather, they can be of any desired configuration, for example in the form of shaped portions on the component 102, grooves, flutes, scores, notches, indents, holes, in particular blind holes, bores, cutouts, apertures and/or the like.

The depressions 118 are spaced apart from one another on the wall portion 116 of the component 102 that encloses the through-passage 114.

The depressions 118 can be formed both in a symmetrical arrangement and in a free arrangement on the wall portion 116 of the component 102.

The fixing device 100 is not restricted to the configuration of such depressions 118. As an alternative to the depressions 118, or also in addition to the depressions 118, it is also possible for the component 102 to have formed on it protrusions 120 which project for example from the wall portion 116 of the component 102 that encloses the through-passage 114.

Such protrusions 120 can be in the form of for example pointed, conical or pyramid-shaped bosses on the component 102.

The protrusions 120 can thus form a structured surface which is formed on the wall portion 116 so as to enclose in particular the through-passage 114.

However, the protrusions 120 are not restricted to such an embodiment; rather, they can be of any desired configuration, for example in the form of shaped portions on the component 102, elevations, corrugations, ridges, wedges, studs, lips and/or the like.

In order for the component 102 to be fixed, the fixing element 110 introduced into the through-passage 114 can be deformed, as is illustrated in FIG. 2.

The deformation of the fixing element 110 provides for the fixing element 110, in particular the free end portion 112 of the fixing element 110, to be plastically deformed and thereby molded into the depressions 118.

The deformed fixing element 110 is thus brought into engagement with the depressions 118 provided on the component 102, so as to form a kind of interlocking between the component 102 and the main body 104.

As a result of the fixing element 110 being molded into the depressions 118, the component 102 is in particular fixed in place relative to the main body 104.

If, instead of the depressions 118 or in addition to the depressions 118, protrusions 120 are formed on the wall portion 116 of the component 102 that encloses the through-passage 114, the deformation results in the fixing element 110 being plastically molded onto these protrusions 120 and, in this way, provides for interlocking between the component 102 and the main body 104.

As a result of the fixing element 110 deforming and engaging in the depressions 118, the component 102 is fixed in position relative to the main body 104, the component 102 being fixed in position in particular in an X direction, Y direction and Z direction.

In addition, as a result of the fixing element 110 deforming and engaging in the depressions 118, it is possible for the component 102 to be secured against rotation relative to the main body 104, i.e. arrested in respect of rotation about a longitudinal axis of the fixing element 110.

The fixing element 110 is preferably deformed by a hot-forming process, in particular a heat-staking process, with the aid of a processing tool (not illustrated in any more detail).

In the case of such a hot-forming process, in particular heat-staking process, a heated punch of the processing tool applies a force to the fixing element 110, so that the fixing element 110 is heated, preferably at least partially melted, by the heated punch under the action of temperature and is plastically deformed under the action of force. The melted material of the fixing element 110 is thereby plastically molded into the depressions 118 and solidifies following cooling.

For this purpose, the widened head region can be formed on the free end portion 112 of the fixing element 110, so that, for the deformation of the fixing element 110, there is sufficient material available to be molded into the depressions 118 in order to fix the component 102.

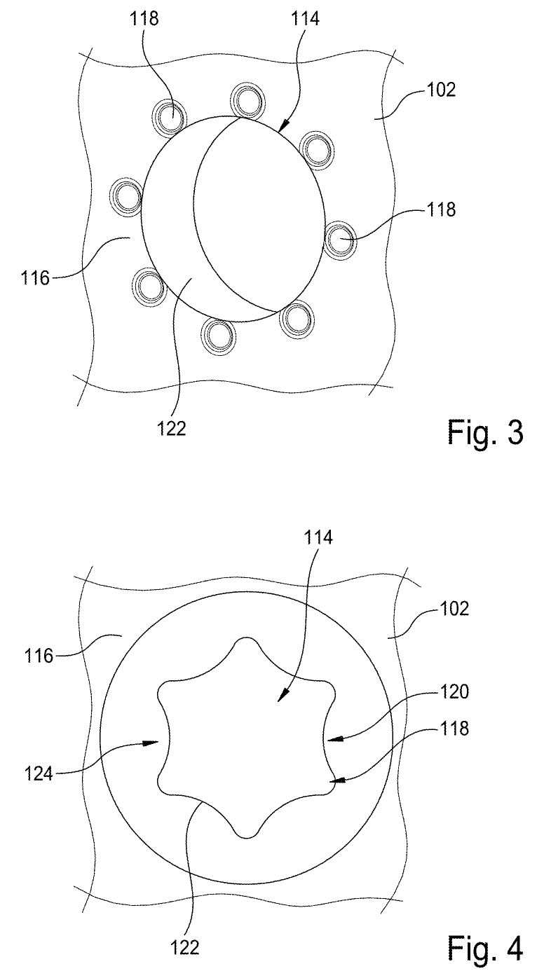

FIGS. 3 to 6 illustrate alternative embodiments of the fixing device 100. The figures each show details of the component 102, FIG. 3 illustrating a perspective view, and FIGS. 4 to 6 illustrating plan views, of the through-passage 114.

In the embodiment according to FIG. 3, the depressions 118 are arranged in a circle, around the through-passage 114, in the wall portion 116 enclosing the through-passage 114.

The depressions 118 are preferably spaced apart uniformly from one another, around the through-passage 114, in the wall portion 116 of the component 102.

The depressions 118 are in the form of round recesses, but, in the manner described above, can be of any desired configuration or can also be in the form of appropriately configured protrusions 120.

In the embodiment illustrated, eight depressions 118 are arranged in a circle, around the through-passage 114, in the wall portion 116 enclosing the through-passage 114.

The depressions 118 are each formed at an angular offset of 45° in relation to one another, around the through-passage 114, in the wall portion 116 of the component 102.

Of course, it is also possible for any other desired number of depressions 118 to be formed, around the through-passage 114, in the wall portion 116 of the component 102. These can be both spaced apart uniformly from one another, i.e. at a defined angular offset, and arranged freely.

In the embodiment according to FIG. 4, six depressions 118 and six protrusions 120 are formed on an inner-wall portion 122 of the through-passage 114.

The depressions 118 and protrusions 120 extend on the inner-wall portion 122 in particular along a through-passage direction of the through-passage 114.

The depressions 118 here are spaced apart from one another in the circumferential direction and extend essentially in a groove-like manner along the through-passage direction of the through-passage 114, so that the protrusions 120 are formed therebetween.

This embodiment of the fixing device 100 is not restricted to the illustrated embodiment with six depressions 118 and six protrusions 120 on the inner-wall portion 122 of the through-passage 114; rather, it can have any desired number of depressions 118 and protrusions 120 on the inner wall portion 122.

Such depressions 118 and protrusions 120 form a cross section of the through-passage 114 having an inner multi-curve profile 124.

In other words, the depressions 118 and protrusions 120 can form a star-shaped cross section of the through-passage 114.

As an alternative, it is likewise possible for depressions 118 and/or protrusions 120 to be circumferentially distributed at certain points on the inner-wall portion 122 of the through-passage 114.

In this configuration of the fixing device 100, as a result of the deformation, the fixing element 110 is molded into the depressions 118 formed on the inner-wall portion 122 of the through-passage 114, and is molded onto the protrusions 120, in order to fix the component 102 in the X, Y and Z directions and/or to secure it against rotation relative to the main body 104.

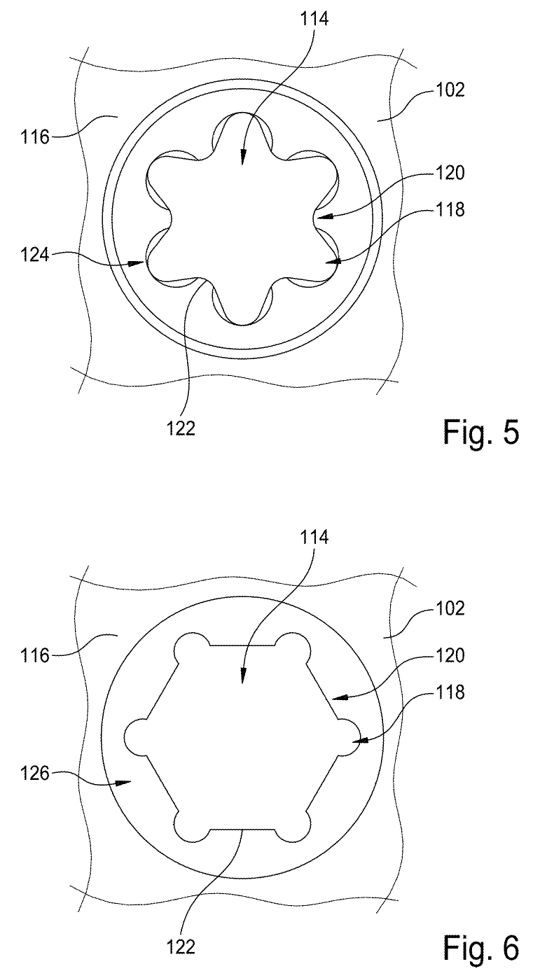

FIG. 5 shows a further embodiment of the fixing device 100, which essentially corresponds to the embodiment according to FIG. 4, the depressions 118 and the protrusions 120 being formed on the inner-wall portion 122 of the through-passage 114 with a different, in particular with a greater, rounding radius.

FIG. 6 shows a further embodiment of the fixing device 100, in which the cross section of the through-passage 114 is essentially polygonal, the through-passage in FIG. 6 having for example an essentially hexagonal cross-section.

Such an essentially polygonal cross section of the through-passage 114 forms an inner multi-edge profile 126.

Depressions 118 are formed at each of the respective corners of the inner multi-edge profile 126 of the through-passage 114, the depressions extending in a groove-like manner along the through-passage direction of the through-passage 114.

The groove-like depressions 118 can be formed both with a rounded groove base, as illustrated in FIG. 6, and with a planar groove base.

Of course, the fixing devices 100 illustrated by way of example can also be in the form of combinations of the embodiments described above. In other words, it is possible for the fixing device 100 to have the depressions 118 and/or protrusions 120 provided on the wall portion 116 enclosing the through-passage 114, as illustrated in FIGS. 1 to 3, and to have the depressions 118 and/or protrusions 120 formed on the inner-wall portion 122 of the through-passage 114, as illustrated in FIGS. 4 to 6.

### List of reference signs

100 Fixing device

102 Component

104 Main body

106 Fastening portion

108 Bearing surface

110 Fixing element

112 End portion

114 Through-passage

116 Wall portion

118 Depression

120 Protrusion

122 Inner-wall portion

124 Inner multi-curve profile

126 Inner multi-edge profile

1. A fixing device for fixing a component, the fixing device comprising:
a main body, on which is provided at least one fastening portion for receiving the component, wherein
the fastening portion has at least one fixing element which can be inserted into a through-passage provided in the component,
the fixing element is at least partially deformed in the through-passage, and
as a result of said deformation, the fixing element is in engagement with at least one depression provided on the component and/or with at least one protrusion provided on the component.

2. The fixing device according to claim 1, wherein, as a result of said deformation, the at least one fixing element is plastically molded into the at least one depression and/or is plastically molded onto the at least one protrusion.

3. The fixing device according to claim 1, wherein, as a result of the at least one deformed fixing element engaging in the at least one depression and/or engaging on the at least one protrusion, the component is fixed in position in at least two spatial directions or in three spatial directions, and/or the component is secured against rotation.

4. The fixing device according to claim 1, wherein the at least one depression and/or the at least one protrusion are/is provided on an inner-wall portion of the through-passage and/or on a wall portion of the component that is adjacent to the through-passage.

5. The fixing device according to claim 1, wherein the at least one depression is in the form of a recess, a shaped portion, a groove, a flute, a score, a notch, an indent, a hole, a blind hole, a bore, a cutout, an aperture, and/or a structured surface.

6. The fixing device according to claim 1, wherein the at least one protrusion is in the form of a boss, a shaped portion, an elevation, a corrugation, a ridge, a wedge, a stud, a lip, and/or a structured surface.

7. The fixing device according to claim 1, wherein a plurality of depressions and/or a plurality of protrusions are provided on the component, and the at least partially deformed fixing element is in engagement therewith for the purpose of fixing the component.

8. The fixing device according to claim 7, wherein the plurality of depressions and/or the plurality of protrusions are spaced apart from one another on the inner-wall portion of the through-passage and/or on a wall portion of the component that encloses the through-passage.

9. The fixing device according to claim 7, wherein the plurality of depressions and/or the plurality of protrusions form a cross section of the through-passage provided in the component, said through-passage cross section having an inner multi-curve profile and/or an inner multi-edge profile.

10. The fixing device according to claim 1, wherein the at least one fixing element is hot formed for the purpose of fixing the component.

11. The fixing device according to claim 1, wherein the at least one fixing element is at least partially formed from a plastics material or from a metal material.

12. The fixing device according to claim 1, wherein the component is in the form of a vehicle component, a busbar, an electronic component, a fastening device, a holder or bracket, a clamp and/or a clip.

13. A method for fixing said component, using said fixing device according to claim 1, the method comprising:
said component which is to be fixed is arranged on said fastening portion of said main body by virtue of said at least one fixing element of the fastening portion being inserted into said through-passage in the component,
the at least one fixing element is deformed, or hot formed, and
the component is fixed by virtue of the at least one deformed, or hot-formed, said fixing element being plastically molded into at least one depression provided on the component and/or being plastically molded onto at least one protrusion provided on the component.

14. The method according to claim 13, wherein, as a result of the fixing element being plastically molded into the at least one depression and/or as a result of the fixing element being plastically molded onto the at least one protrusion, the component is fixed in position in at least two spatial directions, or in three spatial directions, and/or the component is secured against rotation.

15. A method for fixing a component using a fixing device, the method comprising:
a component which is to be fixed is arranged on a fastening portion of a main body by virtue of at least one fixing element of the fastening portion being inserted into at least one through-passage in the component,
the at least one fixing element is deformed, or hot formed, and
the component is fixed by virtue of the at least one deformed, or hot-formed, said fixing element being plastically molded into at least one depression provided on the component and/or being plastically molded onto at least one protrusion provided on the component.
